(19) United States
(12) Patent Application Publication
(10) Pub. No.: US 2016/0325289 A1
(43) Pub. Date: Nov. 10, 2016

(54) Oil-Collecting Electrostatic Precipitator

(71) Applicant: BATTELLE MEMORIAL INSTITUTE, Columbus, OH (US)

(72) Inventors: Michael A. O'Brian, Columbus, OH (US); James E. Dvorsky, Plain City, OH (US)

(21) Appl. No.: 14/777,509

(22) PCT Filed: Mar. 15, 2014
(86) PCT No.: PCT/US14/30006

§ 371 Date: Sep. 15, 2015

Related U.S. Application Data
(60) Provisional application No. 61/800,500, filed on Mar. 15, 2013.
(60) Provisional application No. 61/800,619, filed on Mar. 15, 2013.

(51) Int. Cl. B03C 3/12; B03C 3/41; B03C 3/49; B03C 3/06

(52) U.S. Cl. CPC B03C 3/12; B03C 3/06; B03C 3/41; B03C 3/49; B03C 2201/04

(57) ABSTRACT

An apparatus and a method are provided for removing droplets from a droplet-laden gas by means of an electrostatic precipitator.

### CROSS-REFERENCE TO RELATED APPLICATIONS

This application claims priority from U.S. Provisional Patent Application No. 61/800,619, filed on Mar. 15, 2013, and 61/800,500, filed on Mar. 15, 2013, each of which is incorporated by reference herein in its entirety.

### BACKGROUND

In certain chemical processes, it may be desirable to remove liquid droplets from the process flow of gases and vapors. To collect desired liquid droplets, such as bio-oil droplets from a flow of non-condensable gas (NCG) in the pyrolysis of bio mass, it may be necessary or desirable to employ material separation techniques.

Methods, systems, and apparatuses are needed for removing liquid droplets from NCG.

### SUMMARY

In one embodiment, an electrostatic precipitator is provided, the electrostatic precipitator comprising: a tube, wherein the tube comprises an interior surface and a polarity; a gas flow inlet; a gas flow outlet; at least one corona wire extending within the tube from an isolator to a terminator, wherein the corona wire comprises a polarity; at least one power supply and controller assembly; and a liquid outlet; wherein the polarity of the tube is opposite the polarity of the corona wire.

In another embodiment, an electrostatic precipitator is provided, the electrostatic precipitator comprising: a tube, wherein the tube comprises an interior surface and a polarity; a gas flow inlet; a gas flow outlet; at least one corona wire extending within the tube from a corona wire holder to a terminator, wherein the corona wire comprises a polarity; at least one power supply and controller assembly; and a liquid outlet; wherein the polarity of the tube is opposite the polarity of the corona wire.

In one embodiment, an isolator is provided, the isolator comprising: at least one corona wire magnet operatively connected to a corona wire in an electrostatic precipitator, wherein the corona wire extends through at least a portion of a tube; and at least one base magnet operatively connected to the tube; wherein the corona wire magnet and the base magnet are attracted to one another via a magnetic force.

In one embodiment, a corona wire holder is provided, the corona wire holder comprising: an elongated electrically insulating body; an insert comprising a flared end; and at least one offset spacer comprising at least one anchor tab, wherein the at least one offset spacer is configured to substantially maintain the insert along a longitudinal axis of an electrostatic precipitator tube, and wherein the at least one anchor tab is configured to limit the movement of the corona wire holder when the corona wire holder is placed in the electrostatic precipitator tube.

In one embodiment, an upper corona wire terminator is provided, the terminator comprising: a tensioning element configured to apply tension to a corona wire; a tension spring; a contact spring; a high voltage electrode; and a guide; wherein the high voltage electrode, the contact spring, the tensioning element, the guide, and the corona wire are electrically connected.

In one embodiment, a method for removing droplets from a droplet-laden gas using an electrostatic precipitator is provided, the method comprising: introducing a droplet-laden gas into an electrostatic precipitator via a gas flow inlet; applying a current to at least one corona wire; directing the droplet-laden gas near the at least one corona wire to ionically charge droplets in the droplet-laden gas; directing the ionically charged droplets and gas through a tube, wherein the ionically charged droplets are attracted to an interior surface of the tube; directing a gas out of the electrostatic precipitator via a gas flow outlet; and collecting droplets adhering to the interior surface of the tube after the droplets agglomerate and flow down the interior surface of the tube and out a liquid outlet.

### BRIEF DESCRIPTION OF THE DRAWINGS

The accompanying figures, which are incorporated in and constitute a part of the specification, illustrate example methods, systems, and apparatuses, and are used merely to illustrate example embodiments.

FIG. 1 illustrates an example arrangement of an electrostatic precipitator system.

FIG. 2 illustrates an example arrangement of an electrostatic precipitator system.

FIG. 3 illustrates an example arrangement of a corona wire holder.

FIG. 4 illustrates an example arrangement of a corona wire holder.

FIG. 5 illustrates an example arrangement of a corona wire holder.

FIG. 6 illustrates an example arrangement of a corona wire holder.

FIG. 7 illustrates an example arrangement of an upper corona wire terminator.

FIG. 8 illustrates an example arrangement of an upper corona wire terminator.

FIG. 9 illustrates an example arrangement of a power supply and controller assembly.

FIG. 10 illustrates an example method for using an electrostatic precipitator.

FIG. 11 illustrates an example arrangement of an electrostatic precipitator.

FIG. 12 illustrates an example arrangement of an electrostatic precipitator.

FIG. 13 illustrates an example arrangement of an electrostatic precipitator.

FIG. 14 illustrates an example arrangement of an electrostatic precipitator.

### DETAILED DESCRIPTION

In certain chemical processes, it may be desirable to remove liquid droplets from the process flow of gases and vapors. Such gases and vapors may be referred to herein as droplet-laden gas. One such chemical process is pyrolysis of biomass for the extraction of bio oils.

Pyrolysis processes may include fast pyrolysis of biomass material at temperatures of about 500° C. When biomass undergoes pyrolysis, three groups of components may be created, including: non-condensable gases (“NCG”), vapor that may be quenched into bio oil, and solids known as char. NCG may contain liquid droplets (e.g., bio oil droplets) and, as such, may be a droplet-laden gas. As the extraction of bio oils from biomass may be the objective of pyrolysis, it may be desirable to remove bio oil droplets from NCG to maximize product yield.

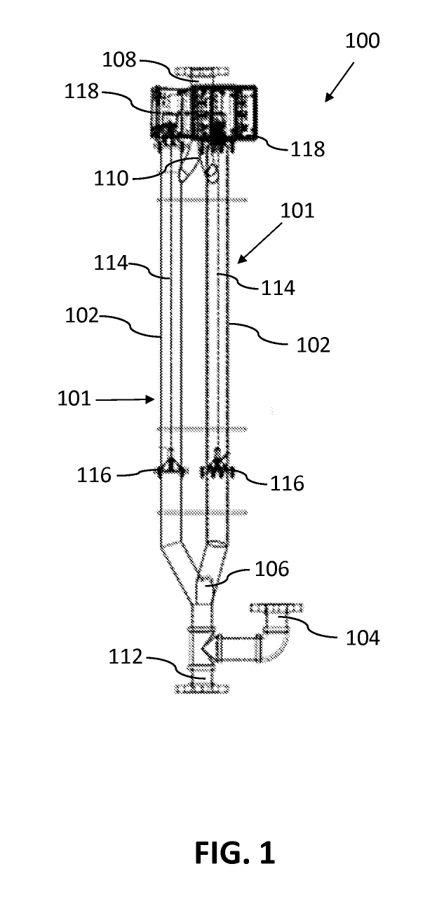

FIG. 1 illustrates an example arrangement of an electrostatic precipitator system 100. In one embodiment, electrostatic precipitator system 100 is configured to process droplet-laden gas having liquid droplets. In another embodiment, electrostatic precipitator system 100 is configured to process NCG having bio oil droplets. In another embodiment, electrostatic precipitator system 100 is configured to collect bio oil droplets from NCG. In another embodiment, electrostatic precipitator system 100 is configured to continuously remove droplets from a stream of droplet-laden gas (e.g., NCG) without having to shut down electrostatic precipitator system 100 to recover the aggregate liquid. The aggregate liquid may be collected in a storage vessel for further processing or use.

In one embodiment, electrostatic precipitator system 100 operates to bombard the liquid droplets with ions that charge the droplets of the droplet-laden gas. The ions may be generated by a corona wire. The charged droplets may then strike and adhere to a collection surface, effectively removing the charged droplets from the droplet-laden gas. In one embodiment, the collection surface is the interior surface of a tube through which the droplet-laden gas travels.

Electrostatic precipitator system 100 may comprise at least one electrostatic precipitator 101. Electrostatic precipitator 101 may comprise a tube 102. System 100 may comprise a gas flow inlet 104, an inlet manifold 106, a gas flow outlet 108, an outlet manifold 110, and a liquid outlet 112, each of which is operatively connected to at least one electrostatic precipitator 101. Each electrostatic precipitator 101 may comprise at least one corona wire 114, at least one corona wire holder 116, and a power supply and controller assembly 118.

System 100 may comprise a plurality of electrostatic precipitators 101. In one embodiment, system 100 comprises a plurality of electrostatic precipitators 101 operating in parallel. In another embodiment, system 100 comprises a plurality of electrostatic precipitators 101 operating in parallel and supplied with droplet-laden gas by a common gas flow inlet 104. Gas flow inlet 104 may direct droplet-laden gas to inlet manifold 106, which substantially divides the droplet-laden gas into multiple streams—one per electrostatic precipitator 101. In one embodiment, system 100 comprises a plurality of electrostatic precipitators 101 sharing a common gas flow outlet 108, wherein gas flows from electrostatic precipitators 101 into outlet manifold 110, which directs gas to gas flow outlet 108 as a single stream.

In one embodiment, electrostatic precipitator 101 comprises a single-stage electrostatic precipitator wherein droplet charging and collection occur within tube 102. Tube 102 may comprise a substantially circular cross-section. Tube 102 may comprise any of a variety of materials suited for processing of droplet-laden gas, including a metal, an alloy, a ceramic, or a polymer. In one embodiment, tube 102 is electrically grounded. In one embodiment, tube 102 comprises a polarity that is opposite from the polarity of corona wire 114.

In one embodiment, droplet-laden gas enters gas flow inlet 104 and travels to inlet manifold 106 wherein the droplet-laden gas is divided into one stream per electrostatic precipitator 101. In one embodiment, each electrostatic precipitator 101 operates independently of the others. In another embodiment, each electrostatic precipitator 101 operates dependently with the others. In one embodiment, each electrostatic precipitator 101 is powered and controlled by its respective power supply and controller assembly 118.

The droplet-laden gas may advance within tube 102 upwardly past corona wire holder 116 and about corona wire 114. Corona wire holder 116 may constrain the lower end of corona wire 114, which is axially oriented within tube 102. Corona wire 114 may generate ions that radiate outward and bombard the droplets of the droplet-laden gas.

Corona wire 114 may comprise any of a variety of apparatuses configured to create a corona. A corona is a process by which an electrical current flows from an electrode with a high potential into a neutral fluid (e.g., a droplet-laden gas) by ionizing the fluid so as to create a region of plasma around the electrode. Droplets in the fluid may thus become charged. In one embodiment, corona wire 114 comprises a polarity that is opposite the polarity of tube 102. Corona wire 114 may be electrically insulated from tube 102. In one embodiment, corona wire holder 116 is configured to electrically insulate corona wire 114 from tube 102.

In one embodiment, charged droplets are acted upon by magnetic forces to strike and adhere to a collection surface. In one embodiment, the collection surface is the interior surface of tube 102. In another embodiment, charged droplets are acted upon by magnetic forces and move along the electric field established within electrostatic precipitator 101 to strike and adhere to the interior surface of tube 102. In another embodiment, charged droplets are acted upon by electromagnetic forces and move along the electric field established within electrostatic precipitator 101 to strike and adhere to the interior surface of tube 102. In one embodiment, charged droplets comprise a polarity that is opposite the polarity of tube 102.

In one embodiment, droplets adhering to the interior surface of tube 102 agglomerate and fall, as a flowing liquid, down the interior surface of tube 102 due to gravitational forces. In one embodiment, the flowing liquid proceeds down the interior surface of tube 102, into inlet manifold 106, and out liquid outlet 112. In another embodiment, a collection vessel (not shown) is operatively connected to or positioned below liquid outlet 112 to collect the flowing liquid. In one embodiment, the flowing liquid is substantially bio oil.

In one embodiment, the processed gas proceeds upwards through tube 102, into outlet manifold 110 and out of gas flow outlet 108.

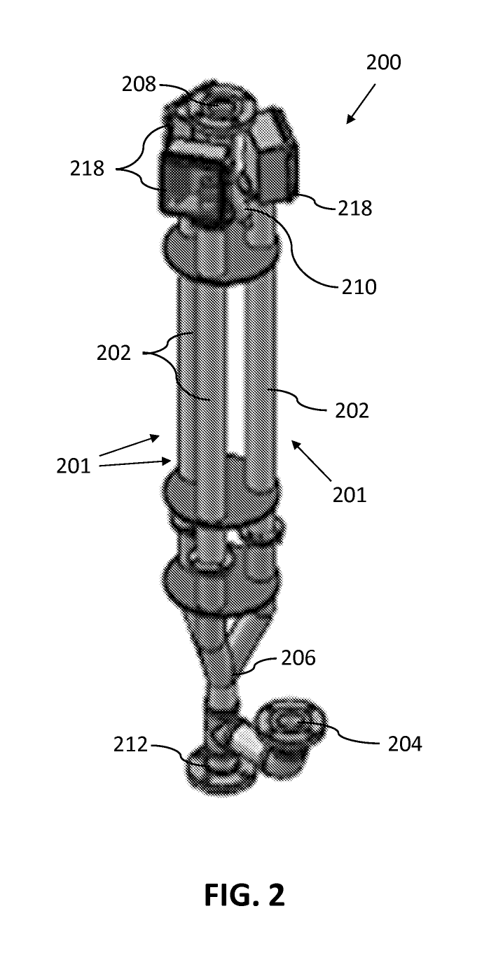

FIG. 2 illustrates an example arrangement of an electrostatic precipitator system 200. Electrostatic precipitator system 200 may comprise at least one electrostatic precipitator 201. Electrostatic precipitator 201 may comprise a tube 202. System 200 may comprise a gas flow inlet 204, an inlet manifold 206, a gas flow outlet 208, an outlet manifold 210, and a liquid outlet 212, each of which is operatively connected to at least one electrostatic precipitator 201. Each electrostatic precipitator 201 may comprise a power supply and controller assembly 218.

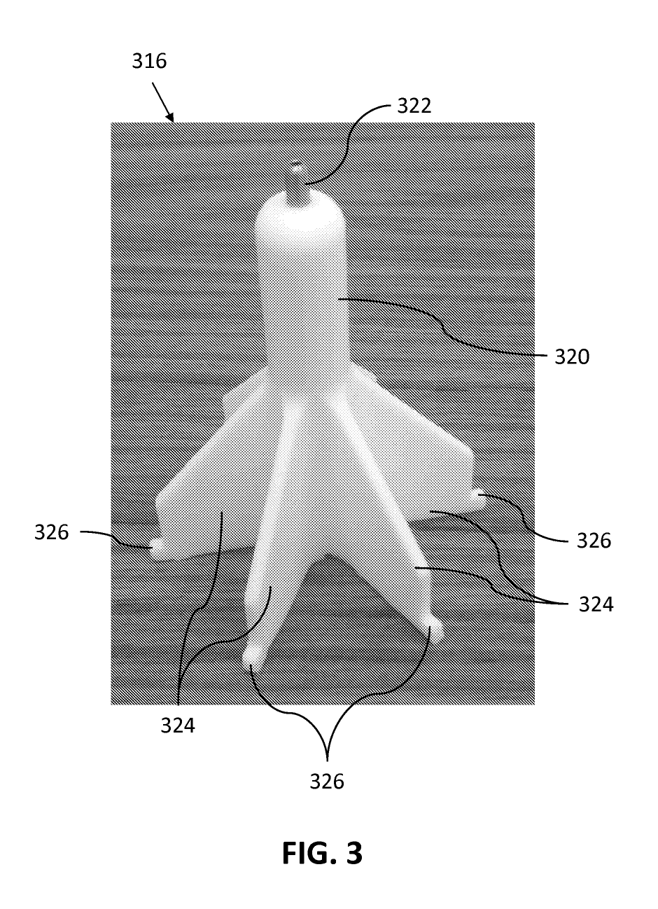

FIG. 3 illustrates an example arrangement of a corona wire holder 316. In one embodiment, corona wire holder 316 is configured to locate a corona wire (such as corona wire 114 illustrated in FIG. 1) along an axis of an electrostatic precipitator tube (such as tube 102 illustrated in FIG. 1). In another embodiment, corona wire holder 316 is configured to anchor one end of a corona wire. In another embodiment, corona wire holder 316 is configured to anchor one end of a corona wire in tension.

In one embodiment, corona wire holder 316 is highly electrically insulating. In another embodiment, corona wire holder 316 is electrically insulating to at least 10 kV. In another embodiment, corona wire holder 316 is electrically insulating to more than 10 kV. In some embodiments, an electrostatic precipitator may operate at 10 kV or greater.

Corona wire holder 316 may comprise an elongated electrically insulating body 320. In one embodiment, an insert 322 extends through at least a portion of elongated body 320. Insert 322 may be comprised of any of a variety of materials, including a metal, an alloy, or a ceramic. In one embodiment, insert 322 comprises a stainless steel.

Electrical insulators may eventually lose resistive characteristics if exposed to intense electric fields over prolonged periods. In one embodiment, insert 322 is configured to reduce the electric field strength to which corona wire holder 316 is exposed. In one embodiment, insert 322 comprises the same potential as a corona wire extending through insert 322 (such as corona wire 114 illustrated in FIG. 1), but the larger radius of insert 322 compared to the corona wire significantly reduces the electric field strength to which corona wire holder 316 is exposed.

Insert 322 may be substantially cylindrical with a longitudinal aperture extending along its length. In one embodiment, insert 322 comprises a rounded end (visible in FIG. 3) and a flared end (oriented within elongated body 320). A corona wire may extend through the interior of insert 322 and be anchored thereto. The flared end of insert 322 may be configured to keep insert 322 oriented within corona wire holder 316 when a corona wire is under tension.

Corona wire holder 316 may comprise at least one offset spacer 324 configured to substantially maintain insert 322 along the central longitudinal axis of an electrostatic precipitator tube (such as 102 illustrated in FIG. 1). In one embodiment, at least one offset spacer 324 is oriented radially outwardly of elongated body 320. In one embodiment, corona wire holder 316 comprises at least two offset spacers 324. In another embodiment, corona wire holder 316 comprises at least three offset spacers 324. In another embodiment, corona wire holder 316 comprises a plurality of offset spacers 324.

In one embodiment, offset spacer 324 is configured to allow a droplet-laden gas to advance upwardly past corona wire holder 316. In another embodiment, offset spacer 324 is configured to allow a flowing liquid to advance downwardly past corona wire holder 316 along the interior surface of an electrostatic precipitator tube. The gaps created between offset spacers 324 may be configured to allow the passage of droplet-laden gas and flowing liquid past corona wire holder 316.

Corona wire holder 316 may comprise at least one anchor tab 326 configured to limit the movement of corona wire holder 316 when placed in an electrostatic precipitator tube (such as 102 illustrated in FIG. 1). In one embodiment, at least one anchor tab 326 is oriented on at least one offset spacer 324. In another embodiment, each offset spacer 324 comprises at least one anchor tab 326. In another embodiment, at least one anchor tab 326 is oriented radially outwardly of elongated body 320.

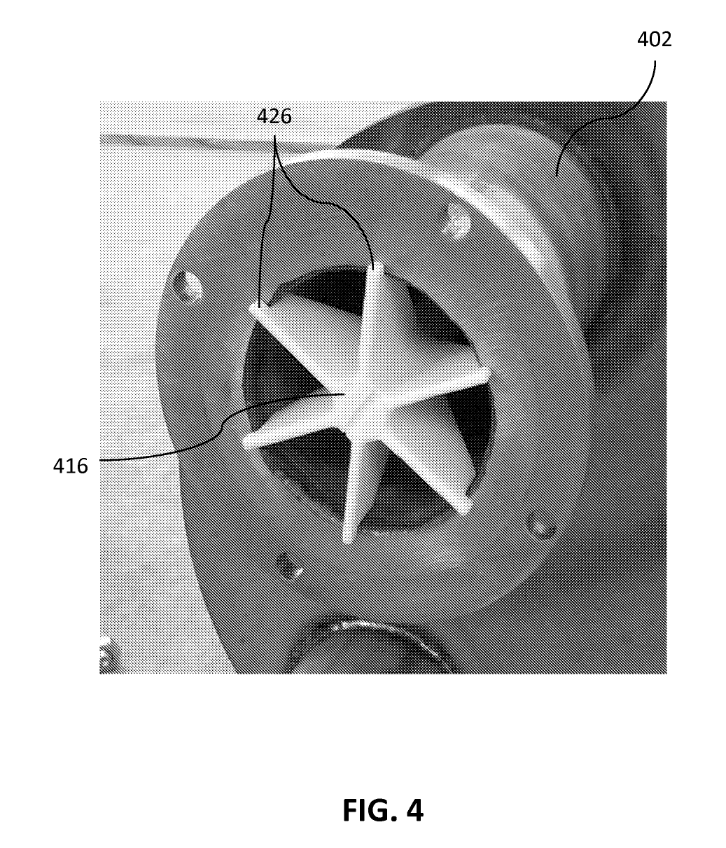

FIG. 4 illustrates a tube 402 containing a corona wire holder 416. Corona wire holder 416 may comprise at least one anchor tab 426 configured to prevent corona wire holder 416 from advancing completely into tube 402. Corona wire holder 416 may be oriented at a joint between sections of tube 402.

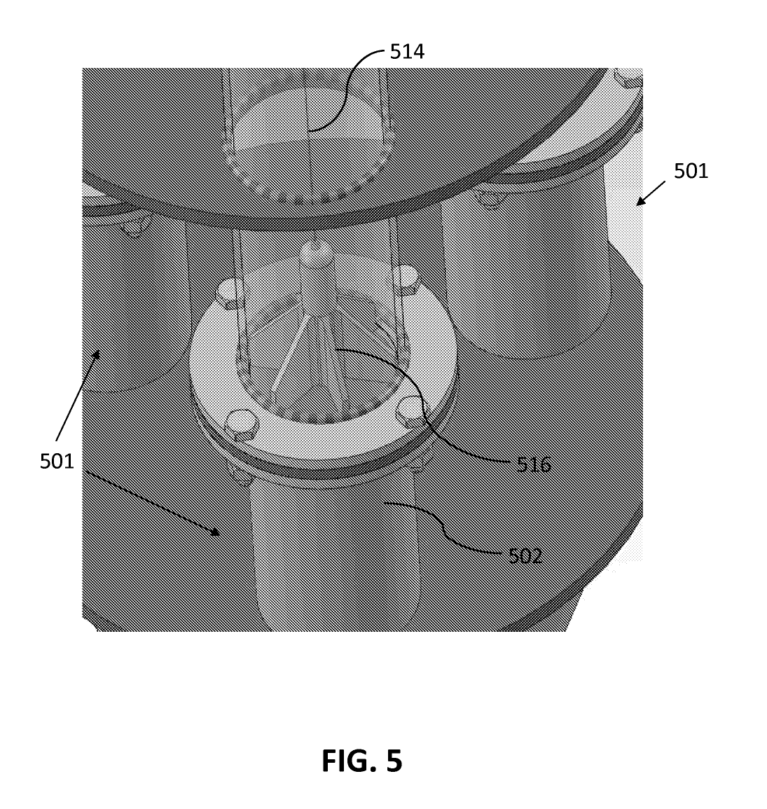

FIG. 5 illustrates a plurality of electrostatic precipitators 501 comprising tubes 502. A corona wire 514 may extend along a longitudinal axis within tube 502, anchored at one end by corona wire holder 516. Corona wire holder 516 may be oriented at a joint between sections of tube 502. In one embodiment, corona wire holder 516 is configured such that it cannot advance completely into tube 502 when tension is applied to corona wire 514.

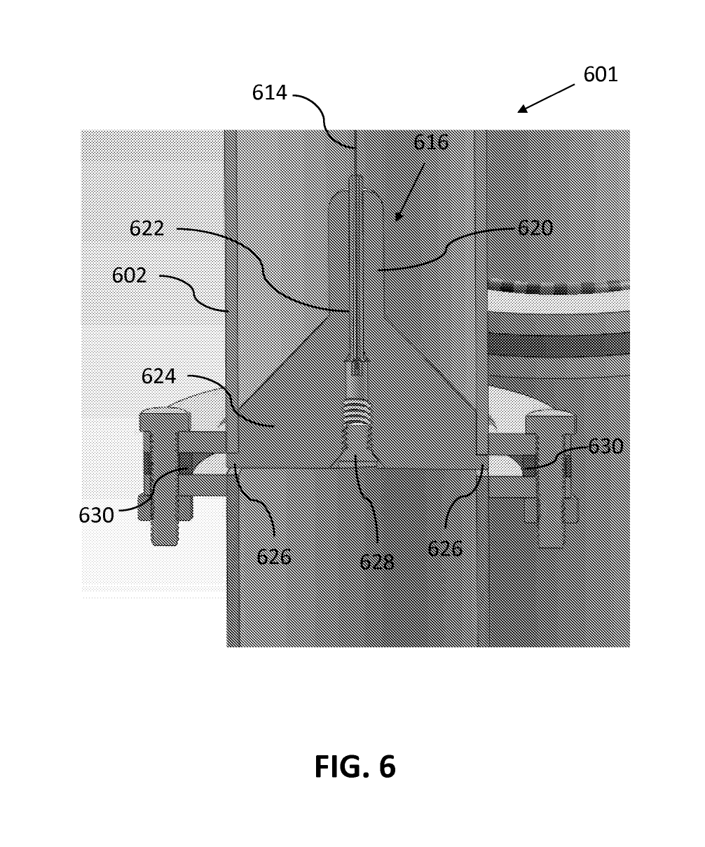

FIG. 6 illustrates an electrostatic precipitator 601 comprising a tube 602. A corona wire 614 may extend along a longitudinal axis within tube 602. Corona wire 614 may be anchored at one end by corona wire holder 616.

Corona wire holder 616 may comprise an elongated body 620, an insert 622, at least one offset spacer 624, and at least one anchor tab 626. Corona wire holder 616 may additionally comprise a threaded plug 628. Plug 628 may comprise any of a variety of materials, including a ceramic or a polymer. Plug 628 may be removed to allow corona wire 614 to be inserted through corona wire holder 616. Plug 628 may be inserted to prevent droplet-laden gas from entering within corona wire holder 616.

Corona wire holder 616 may be oriented at a joint between sections of tube 602. In one embodiment, a gasket 630 is oriented at the joint between sections of tube 602 radially outwardly of corona wire holder 616. Gasket 630 may be configured to prevent ambient air from entering the interior of tube 602. Ambient air may react negatively with pyrolysis products such as droplet-laden gas. In one embodiment, substantially all joints and flanges of electrostatic precipitator 601 comprise gaskets, O-rings, or both to at least substantially preclude the entry of ambient air into the electrostatic precipitator system.

In one embodiment, the droplets of droplet-laden gas comprise a bio oil. A bio oil may be very acidic and electrically conducting. In one embodiment, corona wire holder 616 is configured to at least substantially prevent the conducting of electricity between corona wire 614, or insert 622, and grounded tube 602. Offset spacer 624 may be beveled down and away from corona wire 614 so as to at least substantially prevent bio oil from approaching corona wire 614 as it contacts corona wire holder 616 while flowing down the inner surface of tube 602.

In one embodiment, electrostatic precipitator 601 is configured to operate in continuous mode for extended periods of time. During operation, electrostatic precipitator 601 may be expected to operate continuously without maintenance intervention for long periods of time. Accordingly, corona wire holder 616 may be configured so as to allow the running of electrostatic precipitator 601 for extended periods of time.

Corona wire holder 616 may be comprised of any of a variety of materials, including a polymer, a ceramic, a metal, or an alloy. In one embodiment, corona wire holder 616 comprises polytetrafluoroethylene (PTFE). In another embodiment, corona wire holder 616 comprises Teflon®. In another embodiment, corona wire holder 616 comprises a material that is highly electrically insulating, even at high voltages. In another embodiment, corona wire holder 616 comprises a material that does not chemically interact with pyrolysis products, such as NCG laden with bio oil droplets.

In one embodiment, corona wire holder 616 comprises a material that may creep over time. Accordingly, corona wire 614 tension may be kept at a minimum to minimize the creep of corona wire holder 616. Additionally, stress points in corona wire holder 616 may be broadly distributed (including over insert 622) so as to minimize creep of corona wire holder 616.

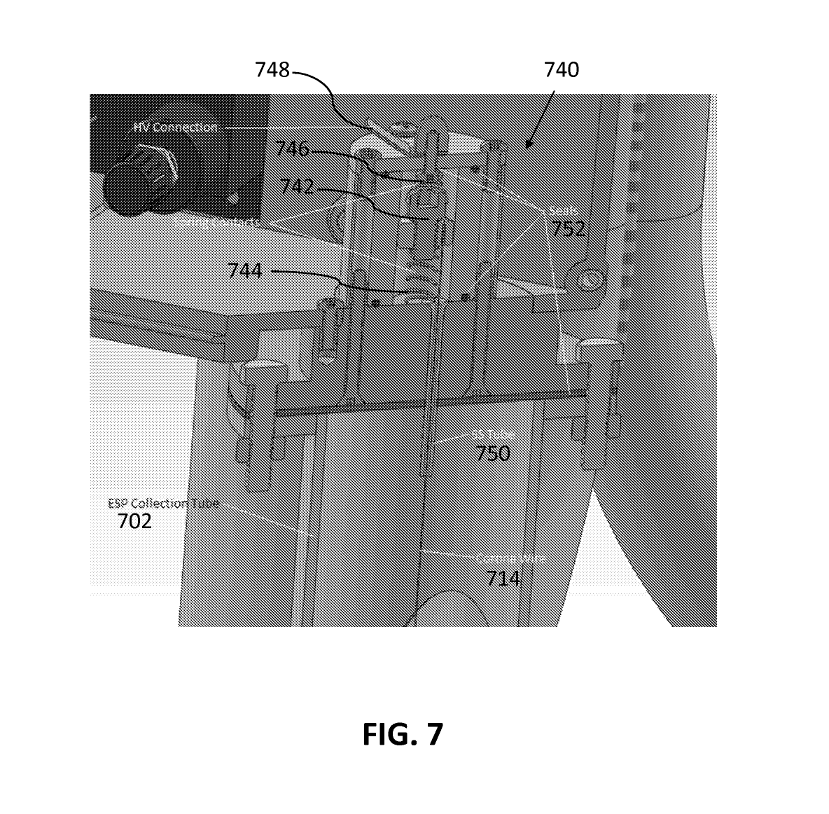

FIG. 7 illustrates an electrostatic precipitator tube 702, through which a corona wire 714 extends. The uppermost portion of tube 702 may comprise an upper corona wire terminator 740. Terminator 740 may comprise a tensioning element 742, a tension spring 744, a contact spring 746, and a high voltage electrode 748. Terminator 740 may additionally comprise a guide 750 through which corona wire 714 may extend. Terminator 740 may comprise at least one seal 752 configured to prevent ambient air from entering the electrostatic precipitator.

Terminator 740 may comprise any of a variety of materials, including a polymer, a metal, an alloy, or a ceramic. In one embodiment, terminator 740 comprises a non-conductive material. In another embodiment, terminator 740 comprises a material capable of withstanding high voltage. In another embodiment, terminator 740 comprises an acetal. In another embodiment, terminator 740 comprises Delrin®. In one embodiment, substantially all of the bio oil is separated from the gas as it contacts terminator 740, and terminator 740 does not necessarily comprise a chemically resistant material.

Tensioning element 742 may be connected to corona wire 714 and may be configured to apply a desired amount of tension to corona wire 714. Tension spring 744 may be configured to press upward on tensioning element 742 to apply a desired amount of tension to corona wire 714. Tensioning element 742 may comprise a nut and bolt assembly configured to cinch corona wire 714 and at least substantially constrain it. Contact spring 746 may be configured to make an electrical connection between tensioning element 742 and high voltage electrode 748.

High voltage electrode 748 may be electrically connected to corona wire 714. In one embodiment, high voltage electrode 748 accepts a current and directs the current into corona wire 714. To energize the electrostatic precipitator, each corona wire 714 may comprise its own dedicated high voltage power source.

Guide 750 may comprise any of a variety of materials, including a metal, an alloy, a ceramic, or a polymer. In one embodiment, guide 750 comprises a stainless steel. The use of stainless steel in guide 750 may be configured to reduce the electric field intensity to which terminator 740 and its electrically insulating portions are exposed.

In one embodiment, high voltage electrode 748, contact spring 746, tensioning element 742, guide 750, and corona wire 714 are electrically connected.

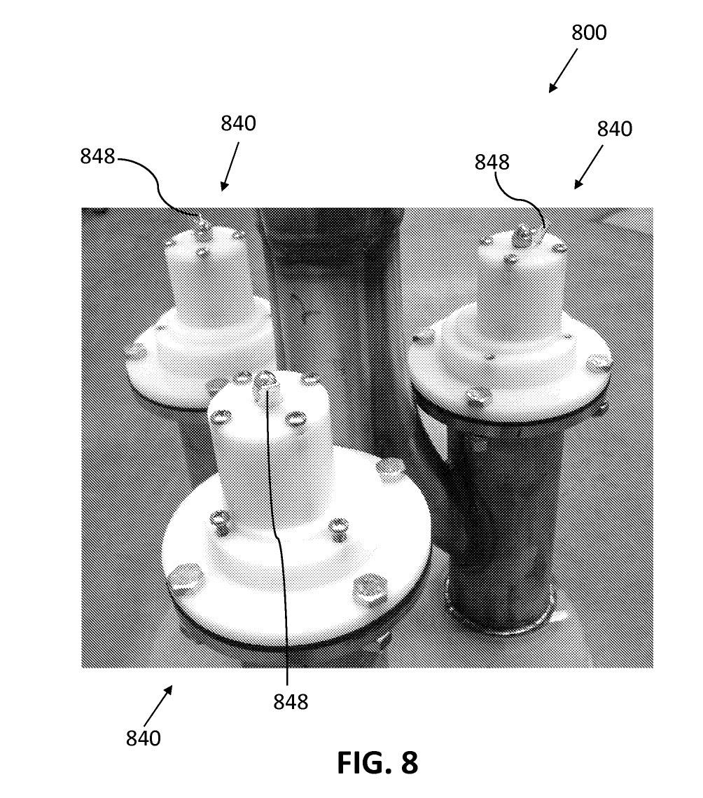

FIG. 8 illustrates an electrostatic precipitator system 800 comprising a plurality of terminators 840. Each terminator 840 may be oriented on top of an electrostatic precipitator tube. Each terminator 840 may comprise a high voltage electrode 848.

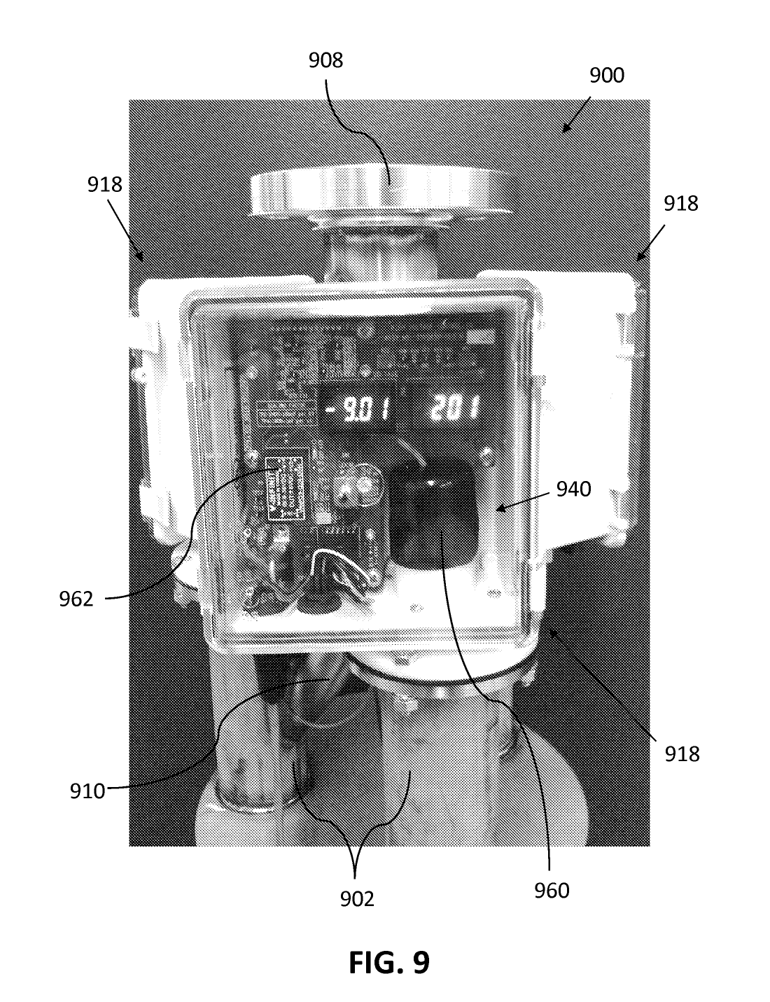

FIG. 9 illustrates an example arrangement of an electrostatic precipitator system 900. System 900 comprises a plurality of tubes 902, a gas flow outlet 908, an outlet manifold 910, and at least one power supply and controller assembly 918.

Assembly 918 may contain a terminator 940. In one embodiment, assembly 918 substantially encases terminator 940 to isolate terminator 940 from a user in order to prevent unintended contact with the high voltage electrode (not shown) of terminator 940.

Terminator 940 may be electrically insulated from contact by a user by a cover 960. Cover 960 may be configured to substantially prevent unintended contact between a user and the high voltage electrode (not shown) of terminator 940.

In one embodiment, each corona wire (not shown) comprises its own dedicated assembly 918. Assembly 918 may comprise a controller 962. Controller 962 may comprise a circuit board, circuitry, and/or a computer.

Assemblies 918 may compensate for slight geometric variations among each electrostatic precipitator in system 900. Assembly 918 may comprise a DC-to-DC converter module capable of operating from a 24 VDC source and supplying up to 15 kV. In one embodiment, each module is adjustable and controller 962 allows for local setting of output voltage and maximum output current. In one embodiment, controller 962 comprises a remote control, such as a programmable logic controller.

In one embodiment, assembly 918 comprises at least one display configured to display output voltage in kV and output current in μA.

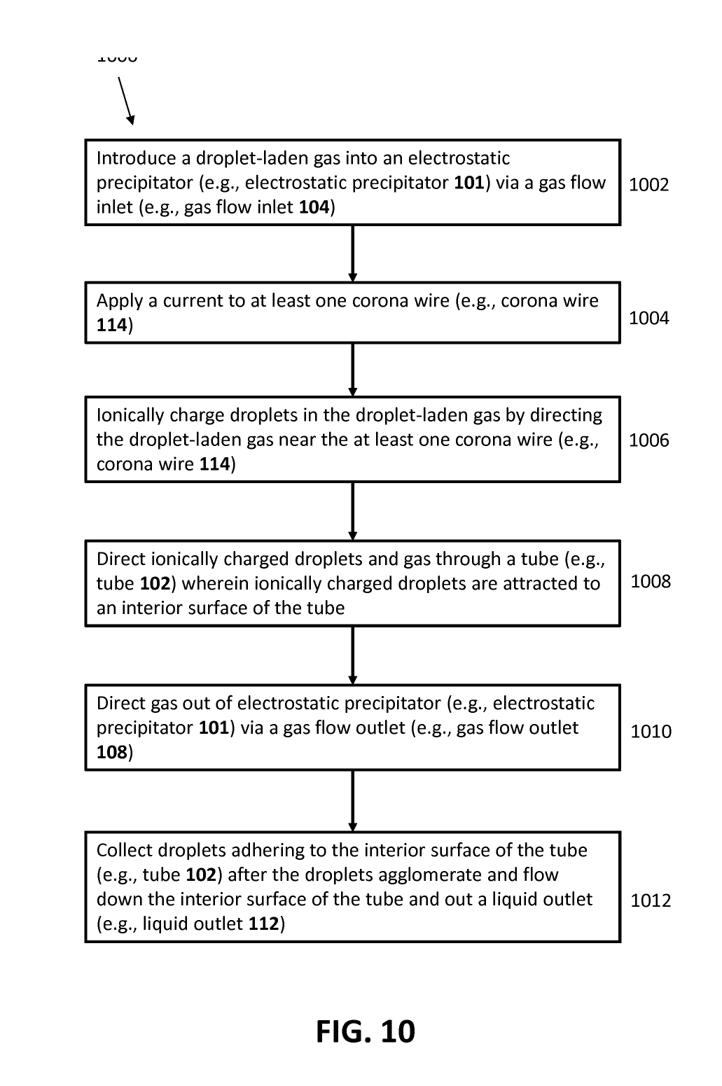

FIG. 10 illustrates an example method 1000 for removing droplets from droplet-laden gas using an electrostatic precipitator. The method includes introducing a droplet-laden gas into an electrostatic precipitator (e.g., electrostatic precipitator 101) via a gas flow inlet (e.g., gas flow inlet 104) (step 1002). A current is applied to at least one corona wire (e.g., corona wire 114) (step 1004). The at least one corona wire is configured to ionically charge droplets in the droplet-laden gas by directing the droplet-laden gas near the at least one corona wire (step 1006). The ionically charged droplets and gas are directed through a tube (e.g., tube 102) wherein ionically charged droplets are attracted to an interior surface of the tube (step 1008). Gas is directed out of the electrostatic precipitator via a gas flow outlet (e.g., gas flow outlet 108) (step 1010). Droplets adhering to the interior surface of the tube (e.g., tube 102) agglomerate and fall, as a flowing liquid, down the interior surface of the tube due to gravitational forces, and out a liquid outlet (e.g., liquid outlet 112) (step 1012).

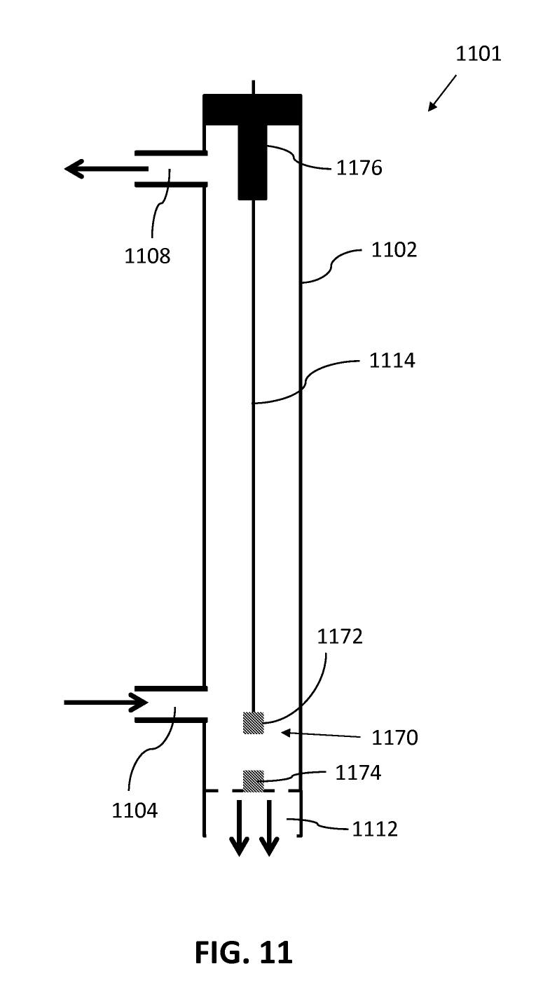

FIG. 11 illustrates an example arrangement of an electrostatic precipitator 1101. Electrostatic precipitator 1101 may include a tube 1102, a gas flow inlet 1104, a gas flow outlet 1108, and a liquid outlet 1112. Electrostatic precipitator 1101 may include a corona wire 1114.

Electrostatic precipitator 1101 may include an isolator 1170. Isolator 1170 may replace a corona wire holder. Isolator 1170 may function to prevent corona wire 1114 from contacting, or coming too close to, tube 1102. Corona wire 1114 may be kept at a distance from a wall of tube 1102 to substantially prevent electricity from traveling between corona wire 1114 and tube 1102. Isolator 1170 may function similarly to an electrical insulator. Isolator 1170 may function to keep corona wire 1114 substantially radially centered within tube 1102.

Isolator 1170 may function to provide a tension to corona wire 1114. In one embodiment, isolator 1170 at least partially retains an end of corona wire 1114. Isolator 1170 may include at least one magnet, including a corona wire magnet 1172, which may be operatively connected to corona wire 114. Isolator 1170 may include at least one magnet, including a base magnet 1174, which may be operatively connected to at least one of a base member and tube 1102. Isolator 1170 may include both at least one corona wire magnet 1172 and at least one base magnet 1174. In one embodiment, corona wire magnet 1172 may be oriented so as to be attracted via magnetic forces to base magnet 1174.

At least one corona wire magnet 1172 may include any of a variety of magnets, including for example at least one of a permanent magnet, a temporary magnet, and an electromagnet. At least one corona wire magnet 1172 may include any of a variety of materials known to be magnetic, including for example Neodymium Iron Boron, Samarium Cobalt, Alnico, Ceramic, or Ferrite.

At least one base magnet 1174 may include any of a variety of magnets, including for example at least one of a permanent magnet, a temporary magnet, and an electromagnet. At least one base magnet 1174 may include any of a variety of materials known to be magnetic, including for example Neodymium Iron Boron, Samarium Cobalt, Alnico, Ceramic, or Ferrite.

In one embodiment, at least one corona wire magnet 1172 and at least one base magnet 1174 are attracted via magnetic forces without actually making contact with one another. At least one corona wire magnet 1172 and at least one base magnet 1174 may be close enough to adequately attract one another to at least one of partially retain and end of corona wire 1114 and provide a tension to corona wire 1114. At least one corona wire magnet 1172 and at least one base magnet 1174 may be far enough away from one another, and tube 1102, to substantially prevent electricity from traveling between corona wire 1114 and tube 1102.

In one embodiment, at least one corona wire magnet 1172 may be attracted to a base member (not shown). In one embodiment, at least one base magnet 1174 may be attracted to corona wire 1114. Attraction between at least one of corona wire magnet 1172 or base magnet 1174, to a base member or corona wire 1114, respectively, may at least one of partially retain an end of corona wire 1114 and provide a tension to corona wire 1114. At least one of corona wire magnet 1172 or base magnet 1174, and a base member or corona wire 1114, respectively, may be attracted via magnetic forces without actually making contact with one another. At least one of corona wire magnet 1172 or base magnet 1174, and a base member or corona wire 1114, respectively, may be close enough to adequately attract one another to at least one of partially retain and end of corona wire 1114 and provide a tension to corona wire 1114. At least one of corona wire magnet 1172 or base magnet 1174, and a base member or corona wire 1114, respectively, may be far enough away from one another, and tube 1102, to substantially prevent electricity from traveling between corona wire 1114 and tube 1102.

Any of various magnets referenced herein may be of a size, shape, and the like, and may include a magnetic attraction, configured to achieve at least partial retention of an end of corona wire 1114, and/or tensioning of corona wire 1114.

Utilizing a gap between magnets referenced herein, and/or a base member or end of corona wire 1114 may eliminate any direct physical connection between the end of corona wire 1114 and a grounded item, such as tube 1102. In some instances, a physical connection between a lower end of corona wire 1114 and a grounded item, such as tube 1102, can allow electricity to travel through a liquid coating that physical connection and make an electrical connection between corona wire 1114 and the grounded item.

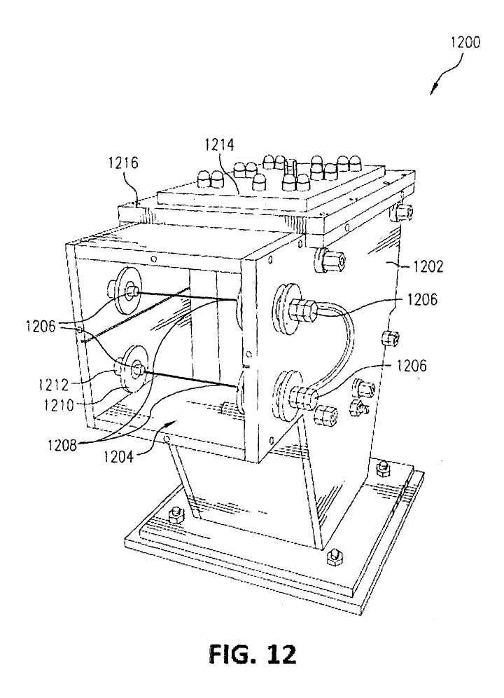

FIG. 12 illustrates an example arrangement of an electrostatic precipitator 1200.

In certain chemical processes, it may be desirable to remove particulates from the process flow of gases and vapors. To maximize the efficiency of processes, including certain chemical processes, or to improve the quality of the output product of a chemical process, it may be necessary to employ material separation techniques. One such chemical process is pyrolysis of biomass for the extraction of bio oils. Pyrolysis of biomass may necessitate removal of particulates from a vapor at a high temperature, low flow rate, or a low pressure. Pyrolysis of biomass may create a char-laden gas. In one embodiment, electrostatic precipitator 1200 is configured to process pyrolysis vapor having one or more of these characteristics.

Pyrolysis processes may include fast pyrolysis of biomass material at temperatures of about 500° C. When biomass undergoes pyrolysis, three groups of components may be created, including: non-condensable gases, vapor that may be quenched into bio oil, and solids known as char. In one embodiment, it is desirable to remove the char from the non-condensable gases and vapor before further processing of these components. In one embodiment, electrostatic precipitator 1200 is configured to remove a char from a non-condensable gas and/or pyrolysis vapor (herein referred to as a char-laden gas).

In one embodiment, electrostatic precipitator 1200 operates to bombard the char material with ions that charge the particles of the char material. The charged particles may then strike and adhere to a collection surface, effectively removing the charged particles of char from the char-laden gas.

Electrostatic precipitator 1200 may comprise a housing 1202, a gas flow inlet 1204, and at least one pair of corona electrodes 1206. Each pair of corona electrodes 1206 may be electrically connected by at least one charging wire 1208. Each corona electrode 1206 may comprise a disk insulator 1210 and/or a rod insulator 1212. Electrostatic precipitator 1200 may also comprise a plate electrode 1214, which may be electrically insulated from housing 1202 by a plate insulator 1216.

Housing 1202 may comprise any of a variety of materials, including a metal, an alloy, a composite, and a polymer. Housing 1202 may comprise a gas flow inlet 1204 and a gas flow outlet (not shown) configured to permit a gas to flow through housing 1202. Housing 1202 may be configured to operate at temperatures at or near about 500° C. in a pyrolysis system. In one embodiment, housing 1202 is electrically grounded.

Corona electrodes 1206 may comprise any of a variety of electrodes configured to create a corona. A corona is a process by which an electrical current flows from an electrode with a high potential into a neutral fluid (e.g., a non-condensable gas or a pyrolysis vapor, either of which may be referred to herein as a char-laden gas) by ionizing the fluid so as to create a region of plasma around the electrode. Particulate matter in the fluid may thus become charged. Corona electrodes 1206 may extend from the outside of housing 1202 to the interior of housing 1202, while being electrically insulated from housing 1202. An electrical current may be applied to corona electrodes 1206. In one embodiment, the electricity applied to corona electrodes 1206 comprises a relatively high voltage.

A pair of corona electrodes 1206 may be electrically connected via charging wire 1208, so as to cause an electrical current to pass through charging wire 1208. Charging wire 1208 may pass substantially across the flow of char-laden gas entering gas flow inlet 1204, such that char-laden gas is directed at or near charging wire 1208.

In one embodiment, a char-laden gas is directed into gas flow inlet 1204, wherein the char particles are ionically charged by charging wire 1208. Charging wire 1208 may emit a corona. Ionically charging the char particles by passing the char-laden gas by charging wire 1208 enables the charged char particles to later strike and adhere to a collector plate.

Disk insulator 1210 may be oriented between charging wire 1208 and housing 1202. Disk insulator 1210 may be configured to at least substantially prevent electrical discharge from charging wire 1208 to housing 1202. In one embodiment, char-laden gas may, at high temperatures, become more conducting to a current than at room temperature. It may be possible for current to pass through the char-laden gas from charging wire 1208 to housing 1202. In one embodiment, disk insulator 1210 is oriented to at least partially prevent such passing of current through the char-laden gas from charging wire 1208 to housing 1202. Disk insulator 1210 may comprise any of a variety of electrically insulating materials, including a ceramic. Disk insulator 1210 may comprise a ceramic material comprising high insulating characteristics even at elevated temperatures.

Rod insulator 1212 may be oriented between corona electrodes 1206 and housing 1202. In another embodiment, rod insulator 1212 is oriented between charging wire 1208 and housing 1202. In another embodiment, rod insulator 1212 is oriented between disk insulator 1210 and housing 1202. Rod insulator 1212 may be configured to at least substantially insulate electricity-carrying components from housing 1202. Housing 1202 may be grounded. Rod insulator 1212 may comprise any of a variety of electrically insulating materials, including a ceramic. Rod insulator 1212 may comprise a ceramic material comprising high insulating characteristics even at elevated temperatures.

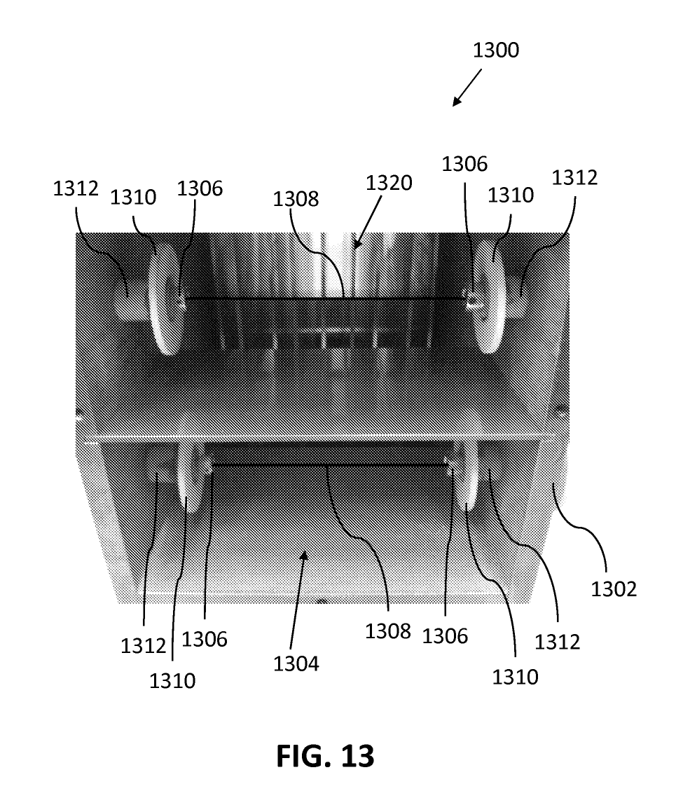

FIG. 13 illustrates an example arrangement of an electrostatic precipitator 1300. Electrostatic precipitator 1300 may comprise a housing 1302, a gas flow inlet 1304, and at least one pair of corona electrodes 1306. Each pair of corona electrodes 1306 may be electrically connected by at least one charging wire 1308. Each corona electrode 1306 may comprise a disk insulator 1310 and/or a rod insulator 1312.

In one embodiment, electrostatic precipitator 1300 comprises a collection plate array 1320 comprising at least two plates comprising different electrical polarity adjacent to one another. In one embodiment, collection plate array 1320 comprises a plurality of interdigiated plates of opposite electrical polarity that create an electrical field between one another. The charged particles in the char-laden gas may pass near or through collection plate array 1320. In one embodiment, at least one of the plates extends downward from the upper portion of housing 1302, and such plates are referred to as charged plates. At least one of the plates extends upward from the lower portion of housing 1302, and such plates are referred to as collection plates. The collection plates may be electrically grounded. The charged plates may be electrically insulated from the rest of housing 1302, using for example plate insulator 1216 illustrated in FIG. 12. An electric potential may be applied to the charged plates, wherein the electric potential may comprise the same polarity as charging wire 1308. In this embodiment, charged particles in char-laden gas may be forced away from the charged plates via magnetic forces acting between the charged plates and the charged particles. Charged particles may be attracted to the collection plates, which are grounded, via magnetic forces acting between the collection plates and the charged particles.

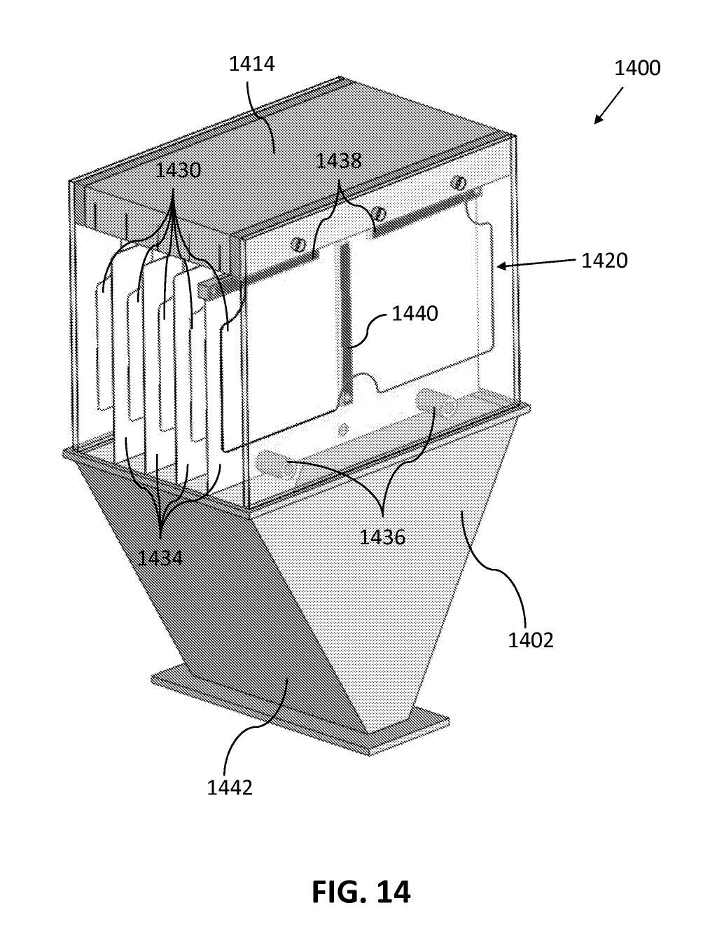

FIG. 14 illustrates an example arrangement of an electrostatic precipitator 1400. Electrostatic precipitator 1400 may comprise a housing 1402 operatively connected to a plate electrode 1414.

Electrostatic precipitator 1400 may comprise a collection plate array 1420 comprising at least one charged plate 1430 extending from plate electrode 1414. In one embodiment, collection plate array 1420 comprises a plurality of charged plates 1430. In another embodiment, at least one charged plate 1430 extends downwardly from plate electrode 1414 and is electrically insulated from housing 1402. In one embodiment, at least one charged plate 1430 and plate electrode 1414 comprise an electric potential having the same polarity as the charging wire (not shown).

Collection plate array 1420 may comprise at least one collection plate 1434 connected to housing 1402 via at least one collection plate connection member 1436. In one embodiment, collection plate array 1420 comprises a plurality of collection plates 1434. In another embodiment, at least one collection plate 1434 extends upwardly from collection plate connection member 1436. In one embodiment, at least one collection plate 1434 is electrically grounded.

In one embodiment, char collects on at least one collection plate 1434. Char may collect on at least one collection plate 1434 to such an extent that char must be removed so that at least one collection plate 1434 may continue to collect char. In one embodiment, electrostatic precipitator 1400 is configured to operate in a batch mode, such that a certain volume of char-laden gas is processed after which electrostatic precipitator is shut down and char may be removed from at least one collection plate 1434. In another embodiment, electrostatic precipitator 1400 is configured to operate in a continuous mode such that electrostatic precipitator 1400 may not be shut down to allow manual removal of char from at least one collection plate 1434 by a user.

In one embodiment, electrostatic precipitator 1400 comprises at least one wiper 1438 and 1440 configured to physically contact at least one collection plate 1434 and remove char from at least one collection plate 1434. In one embodiment, electrostatic precipitator 1400 comprises at least one upper wiper 1438. In another embodiment, electrostatic precipitator 1400 comprises at least one lower wiper 1440. In another embodiment, electrostatic precipitator 1400 comprises at least one upper wiper 1438 and at least one lower wiper 1440.

At least one upper wiper 1438 may be operatively connected to an upper corner of at least one collection plate 1434. At least one upper wiper 1438 may be configured to pivot near its end and travel in an arc about 90 degrees from a position substantially parallel to the upper edge of at least one collection plate 1434 to a position substantially parallel to a side edge of at least one collection plate 1434. In one embodiment, two upper wipers 1438 may be in a substantially opposed orientation, such that each arcs down away from the center of at least one collection plate 1434 to opposing edges of at least one collection plate 1434.

At least one lower wiper 1440 may be operatively connected to at least one collection plate 1434 at a point near the center of the lower edge of at least one collection plate 1434. At least one lower wiper 1440 may be configured to pivot near its end and travel in an arc about 180 degrees, from a position substantially parallel to the lower edge of at least one collection plate 1434 (e.g., facing toward a first edge of collection plate 1434), upwardly arcing about the face of at least one collection plate 1434 to a position substantially parallel to the lower edge of at least one collection plate 1434 (e.g., facing toward a second edge of collection plate 1434). As illustrated in FIG. 4, at least one lower wiper 1440 is oriented in its upward-most position approximately 90 degrees through its arc of movement.

In one embodiment, each of a plurality of collection plates 1434 comprise at least one upper wiper 1438 and/or at least one lower wiper 1440. In one embodiment, each of corresponding upper wiper 1438 and lower wiper 1440 is linked via a rod (not shown), whereby upper wipers 1438 on adjacent collection plates 1434 may move concurrently with one another and lower wipers 1440 on adjacent collection plates 1434 may move concurrently with one another. In one embodiment, electrostatic precipitator 1400 is operatively connected to at least one actuator configured to actuate at least one upper wiper 1438 and at least one lower wiper 1440.

In one embodiment, at least one upper wiper 1438 and/or at least one lower wiper 1440 may extend about opposing faces of collection plate 1434 at the same time. That is, a portion of at least one upper wiper 1438 and at least one lower wiper 1440 may extend through or around collection plate 1434 such that the leg of the wiper extending along a first face of collection plate 1434 is integrally connected with the leg of the wiper extending along a second face of collection plate 1434. In another embodiment, at least one of upper wiper 1438 and lower wiper 1440 comprises a leg extending along a first face of a collection plate 1434 and a leg extending along a second face of a collection plate 1434, wherein the two legs are not integrally connected.

In one embodiment, housing 1402 comprises a hopper 1442 oriented substantially below collection plate array 1420. Char discharged from collection plate array 1420 may be allowed to fall via gravity into hopper 1442. In one embodiment, hopper 1442 may be emptied of char manually. In another embodiment, hopper 1442 may be emptied of char automatically utilizing an auger, belt, or other material transport mechanism.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See Bryan A. Garner, A Dictionary of Modern Legal Usage 624 (2d. Ed. 1995). Also, to the extent that the terms “in” or “into” are used in the specification or the claims, it is intended to additionally mean “on” or “onto.” To the extent that the term “selectively” is used in the specification or the claims, it is intended to refer to a condition of a component wherein a user of the apparatus may activate or deactivate the feature or function of the component as is necessary or desired in use of the apparatus. To the extent that the term “operatively connected” is used in the specification or the claims, it is intended to mean that the identified components are connected in a way to perform a designated function. To the extent that the term “substantially” is used in the specification or the claims, it is intended to mean that the identified components have the relation or qualities indicated with degree of error as would be acceptable in the subject industry. As used in the specification and the claims, the singular forms “a,” “an,” and “the” include the plural. Finally, where the term “about” is used in conjunction with a number, it is intended to include ±10% of the number. In other words, “about 10” may mean from 9 to 11.

As stated above, while the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art, having the benefit of the present application. Therefore, the application, in its broader aspects, is not limited to the specific details, illustrative examples shown, or any apparatus referred to. Departures may be made from such details, examples, and apparatuses without departing from the spirit or scope of the general inventive concept.

1-103. (canceled)

104. A biofuel production system, comprising:
a catalytic vapor phase reactor (VPR);
a pyrolysis reactor operatively connected to the catalytic VPR;
a quench system operatively connected to the catalytic VPR;
a water gas shift reactor operatively connected to the quench system; and
a hydrotreatment system operatively connected to the quench system.

105. The biofuel production system of claim 1, the pyrolysis reactor being configured to pyrolyze a biomass to produce a pyrolysis vapor and char, the system further comprising a char removal system configured to remove the char from the pyrolysis reactor.

106. The biofuel production system of claim 1, further comprising a heater operatively coupled to the pyrolysis reactor, the heater being configured to at least one of internally and externally heat pyrolysis reactor to a temperature between about 300° C. and about 600° C.

107. The biofuel production system of claim 106, the heater comprising one or more of a resistive heating element, a combustor, a heat exchanger, or a microwave generator.

108. The biofuel production system of claim 1, the catalytic VPR comprising a catalyst comprising one or more of: a granulated catalyst; a powdered catalyst; a fluid catalytic cracking catalyst (FCC); fresh FCC; spent FCC; catalyst impregnated on top of the fresh FCC; catalyst impregnated on top of the spent FCC;
the granulated catalyst characterized by a granule size between about 50 μm and about 100 μm;
the granulated catalyst characterized by a size distribution of granules, a substantial fraction of the size distribution being greater than about 20 μm; and
a catalyst selected to catalyze at least one of: deoxygenation, cracking, water-gas shift, and hydrocarbon formation.

109. The biofuel production system of claim 1, the pyrolysis reactor and the catalytic VPR being configured together as a single unit.

110. The biofuel production system of claim 1, further comprising a conversion system operatively coupled to one or more of: the catalytic vapor phase reactor, the pyrolysis reactor, and the hydrotreatment system; the conversion system being configured to produce a hydrocarbon product from biomass by upgrading a bio-oil produced by one or more of: the catalytic vapor phase reactor, the pyrolysis reactor, and the hydrotreatment system.

111. A method for catalytic pyrolysis of biomass, the method comprising:
drying a biomass;
pyrolyzing the biomass to create a pyrolysis vapor;
removing at least one of a char and an ash from the pyrolysis vapor;
upgrading the pyrolysis vapor by vapor phase catalysis to produce an upgraded pyrolysis vapor; and
condensing a bio-oil from the upgraded pyrolysis vapor.

112. The method of claim 111, pyrolyzing the biomass being conducted at one or more of:
a temperature between about 300° C. and about 600° C.; and
at a biomass residence time of about 2 seconds or less.

113. The method of claim 111, upgrading the pyrolysis vapor by vapor phase catalysis to produce the upgraded pyrolysis vapor being conducted after pyrolyzing the biomass to create the pyrolysis vapor and removing at least one of the char and the ash from the pyrolysis vapor, and before condensing the bio-oil from the upgraded pyrolysis vapor.

114. The method of claim 111, the pyrolysis vapor comprising one or more of: water, an organic acid, an aldehyde, a phenol, and a sugar; or one or more derivatives thereof.

115. The method of claim 111, upgrading the pyrolysis vapor by vapor phase catalysis comprising one or more of:
deoxygenating the pyrolysis vapor to produce the upgraded pyrolysis vapor;
cracking one or more higher molecular weight components of the pyrolysis vapor to produce the upgraded pyrolysis vapor;
contacting the pyrolysis vapor to one or more of: a granulated catalyst, a powdered catalyst, and a fluid catalytic cracking catalyst (FCC);
contacting the pyrolysis vapor to one or more of: fresh FCC, spent FCC, catalyst impregnated on top of the fresh FCC, and catalyst impregnated on top of the spent FCC;
contacting the pyrolysis vapor to the granulated catalyst, the granulated catalyst characterized by particle size and flow characteristics substantially similar to the FCC;
contacting the pyrolysis vapor to a granulated catalyst characterized by a granule size between about 50 μm and about 100 μm; and
contacting the pyrolysis vapor to a granulated catalyst characterized by a size distribution of granules, a substantial fraction of the size distribution being greater than about 20 μm.

116. The method of claim 111, further comprising one or more of:
producing a non-condensable gas comprising CO during the pyrolyzing the biomass;
reacting the non-condensable gas comprising CO in a water gas shift reaction to form at least one of hydrogen and CO₂; and
hydrotreating the bio oil with hydrogen from the water gas shift reaction to produce a hydrocarbon fuel product.

117. The method of claim 111, comprising:
drying the biomass in a biomass dryer;
placing the biomass in a pyrolysis reactor and pyrolyzing the biomass at about 500° C. to create a pyrolysis vapor;
directing the pyrolysis vapor to a char and ash removal system and removing at least one of a char and an ash from the pyrolysis vapor;
directing the pyrolysis vapor to a catalytic vapor phase reactor and upgrading the pyrolysis vapor to form an upgraded pyrolysis vapor;
directing the upgraded pyrolysis vapor to a condenser; and
extracting a bio-oil from the condenser.

118. A catalytic vapor phase reactor apparatus, the apparatus comprising:
a gas-solid catalytic reactor;
a feeding auger;
a return auger;
a hot blower;
a first blower;
a second blower;
a first cyclone;
a second cyclone;
a third cyclone;
a split connection;
a dip leg pipe operatively coupled to the split connection;
a fluidized bed reactor;
a bypass connection; and
a catalyst feeding vessel;
the feeding auger and the return auger being operatively connected to the gas-solid catalytic reactor and the fluidized bed reactor;
the first cyclone and the second cyclone being operatively connected to the gas-solid catalytic reactor; and
the third cyclone being operatively connected to the fluidized bed reactor, the first blower, and the second blower.

119. The catalytic vapor phase reactor apparatus of claim 118, further comprising a heater operatively coupled to the gas-solid catalytic reactor, the heater comprising one or more of: a resistive heating element, a combustor, a heat exchanger, and a microwave generator.

120. The catalytic vapor phase reactor apparatus of claim 118, the gas-solid catalytic reactor comprising a raining bed reactor configured to contact the pre-upgrade pyrolysis gas and the catalyst.

121. The catalytic vapor phase reactor apparatus of claim 118, the fluidized bed reactor being operatively connected to at least one of the first blower and the second blower.

122. The catalytic vapor phase reactor apparatus of claim 118, feeding auger and return auger being operatively connected for feeding of a catalyst into the gas-solid catalytic reactor and the fluidized bed reactor, and recirculation of catalyst between gas-solid catalytic reactor and fluidized bed reactor.

123. The catalytic vapor phase reactor apparatus of claim 118, comprising a catalyst comprising one or more of: a granulated catalyst; a powdered catalyst; a fluid catalytic cracking catalyst (FCC); fresh FCC; spent FCC; catalyst impregnated on top of the fresh FCC; catalyst impregnated on top of the spent FCC; the granulated catalyst, characterized by a granule size between about 50 μm and about 100 μm; the granulated catalyst, characterized by a size distribution of granules, a substantial fraction of the size distribution being greater than about 20 μm; and a catalyst configured to catalyze at least one of: deoxygenation, cracking, water-gas shift, and hydrocarbon formation.
